(19) United States
(12) Patent Application Publication
(10) Pub. No.: US 2024/0181537 A1
(43) Pub. Date: Jun. 6, 2024

(54) ELECTROSTATIC RECOATER

(71) Applicant: VulcanForms Inc., Burlington, MA (US)

(72) Inventors: William Curtis Stone, Tewksbury, MA (US); Stephen Elliot Wei, Medford, MA (US); Lucas Buermeyer, Ayer, MA (US)

(73) Assignee: VulcanForms Inc., Burlington, MA (US)

(21) Appl. No.: 18/524,356

(22) Filed: Nov. 30, 2023

Related U.S. Application Data
(60) Provisional application No. 63/429,265, filed on Dec. 1, 2022.

(51) Int. Cl. B22F 12/60; B22F 10/28

(52) U.S. Cl. CPC B22F 12/60; B22F 10/28; B33Y 10/00

(57) ABSTRACT

An electrostatic recoater having an electrode and dielectric shield mounted to a lower surface of the electrode. The dielectric shield and electrode can be movable relative to each other at an interface and/or the dielectric shield may be removably mounted to the electrode.

### RELATED APPLICATIONS

This application claims priority under 35 U.S.C. § 119(e) to U.S. Provisional Application No. 63/429,265, filed Dec. 1, 2022, the content of which is incorporated by reference in its entirety for all purposes.

### FIELD

Disclosed embodiments are generally related to an electrostatic recoater used in additive manufacturing systems.

### BACKGROUND

Additive manufacturing systems employ various techniques to create three-dimensional objects from two-dimensional layers. After a layer of precursor material is deposited onto a build surface, a portion of the layer may be fused through exposure to one or more energy sources to create a desired two-dimensional geometry of solidified material within the layer. Next, the build surface may be indexed, and another layer of precursor material may be deposited. For example, the build surface may be indexed downwardly by a distance corresponding to a thickness of a layer, precursor material may be deposited and then selected portions of the layer fused. This process may be repeated layer-by-layer to fuse many two-dimensional layers into a three-dimensional object.

### SUMMARY

In some additive manufacturing systems, ensuring that the layer of precursor material is suitably consistent in thickness and has a smooth top surface is important to creating a part with desired characteristics. For example, a layer of precursor material that is not suitably smooth may create a part with undesired surface roughness and/or layer thickness variations that are not acceptable. In some cases, an electrostatic recoater is used to smooth the surface of a layer of precursor material. The electrostatic recoater creates an electric field at the surface of the precursor material layer that causes particles of the precursor material to move so that the surface is more flat or smooth.

In some cases, electrostatic recoaters must employ a relatively high electric field to smooth a layer of precursor material and/or are exposed to relatively high temperatures during a smoothing process. For example, systems that use laser energy to melt metal-based precursor material create significant heat at the build surface that may not quickly dissipate. Thus, when a recoater moves over the build surface to smooth a layer of precursor material, the recoater may be exposed to relatively high temperatures. The high temperature environment and/or high electric field requirements for electrostatic recoaters can expose a recoater to extreme conditions that can cause a recoater to fail, e.g., due to thermal stresses. Also, a recoater that operates in an argon or other inert environment and with high electrical fields can require the recoater to be electrically insulated or otherwise configured to operate properly in the inert environment. That is, argon and other inert environment gasses can have a relatively low dielectric constant as compared to standard air. As a result, high voltage potentials, e.g., present at connectors, gaps between components or other portions of a recoater, may be more likely to cause arcing or other short circuiting than would be the case in standard air. Aspects of the disclosure provide electrostatic recoater features that can help a recoater operate properly in high temperature environments, inert gas environments and/or with high electrical field generation.

In some embodiments, an electrostatic recoater for leveling a powder material for an additive manufacturing system includes an electrode having a surface, e.g., a lower surface, and configured to generate an electric field below the lower surface when provided with an alternating electric voltage. For example, the electrode may include a conductive element surrounded by an insulating material, and the conductive element and insulating material may define a planar structure that includes the lower surface. A dielectric shield may extend over at least a part of the lower surface at an interface between the dielectric shield and the electrode, e.g., so the dielectric shield can be positioned between a build surface and the electrode. In some cases, the dielectric shield may be attached to the electrode such that the dielectric shield and the electrode are movable relative to each other in directions along the interface, e.g., so that the dielectric shield and electrode can move relative to each other in response to changes in temperature or other conditions. For example, the interface may be planar and the dielectric shield and electrode may be movable relative to each other in directions parallel to the plane of the interface. This may allow the recoater to be exposed to relatively high temperature fluctuations while helping to reduce the likelihood of delamination of the dielectric shield and electrode.

In some embodiments, the dielectric shield may be removably coupled to a surface of the electrode, e.g., for positioning between the electrode and the powder material. Such removable coupling may be provided so as to allow movement of the dielectric shield and electrode relative to each other in directions along an interface between the two, or not, e.g., the shield may be prevented from movement relative to the electrode in one or more directions along the interface. In some cases, a clamp may apply a force to the dielectric shield in a direction perpendicular to the lower surface of the electrode to hold the dielectric shield in contact with the lower surface. For example, the clamp may include a frame with inner edges that define an opening, and the clamp may be positioned over the dielectric shield such that a portion of the dielectric shield is positioned in the opening and the inner edges of the clamp engage with portions of the dielectric shield to press the dielectric shield onto the lower surface of the electrode. The dielectric shield may be compressed into contact with the electrode by the clamp, e.g., so the shield and electrode can move relative to each other in directions along an interface between the two, or not. The clamp may be removable or otherwise operated to allow the shield to be removed from the electrode, e.g., for replacement.

In some cases, the dielectric shield may be or include a planar layer of dielectric material, such as a borosilicate glass or ceramic material. The shield may have a suitable dielectric constant to permit the recoater to generate a suitable electric field at the surface of precursor material at a build surface, e.g., to move particles of the precursor material so as to level or smooth the surface. The dielectric shield may operate to help prevent electrostatic attachment of precursor material particles on portions of the electrode, e.g., on its lower surface. In some embodiments, an interface layer may be provided between the dielectric shield and the electrode at the interface. The interface layer may permit movement of the dielectric shield relative to the electrode in directions along an interface between the shield and the electrode and/or permit the shield to be removed from the electrode. As an example, the interface layer may include an adhesive configured to adhere to at least the dielectric shield and optionally the electrode. The interface layer may help prevent corona discharge or arcing in a space between the shield and the electrode, e.g., caused by relatively low dielectric constant inert gas used in a build area around the build surface and/or precursor material that may enter the space between the shield and the electrode.

In some embodiments, a method for additive manufacturing comprises providing an alternating electric voltage to an electrode, generating an electric field below a lower surface of the electrode wherein a dielectric shield extends over the lower surface at an interface between the dielectric shield and the electrode. The method further comprises permitting movement of the electrode and/or the dielectric shield relative to one another in directions along the interface.

In some further embodiments, a method for additive manufacturing comprises providing an alternating electric voltage to an electrode to generate an electric field, removably coupling a dielectric shield to a surface of the electrode to position the dielectric shield between the surface of the electrode and a layer of powder material, and leveling the layer of powder material using the electric field.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

Other advantages and novel features of the present disclosure will become apparent from the following detailed description of various non-limiting embodiments of the disclosure when considered in conjunction with the accompanying figures.

### BRIEF DESCRIPTION OF DRAWINGS

In the drawings, each identical or nearly identical component that is illustrated in various figures may be represented by a like numeral. For purposes of clarity, not every component may be labeled in every drawing. In the drawings:

FIG. 1 shows a schematic representation of an additive manufacturing system according to some embodiments;

FIG. 2A shows a top perspective view of an electrostatic recoater and its respective connector disconnected from the electrode, according to some embodiments;

FIG. 2B shows a cross sectional view of the electrostatic recoater of FIG. 2A along the line A-A with the connector mated to the electrode;

FIG. 2C shows the cross sectional view of the electrostatic recoater of FIG. 2B with the connector disconnected from the electrode;

FIG. 3 shows a cross-section side view of an electrostatic recoater with a dielectric shield mounted by a clamp, according to some embodiments;

FIG. 4 shows a perspective view of the electrostatic recoater of FIG. 3;

FIG. 5 shows a cross-section of a side perspective view of an electrostatic recoater with a frame mount for the dielectric shield, according to some embodiments;

FIG. 6 show a perspective bottom view of an electrostatic recoater with a frame mount for the dielectric shield, according to some embodiments; and

FIG. 7 shows a cross-section view of an embodiment of a connector for an electrostatic recoater.

### DETAILED DESCRIPTION

It should be understood that aspects of the invention are described herein with reference to the figures, which show illustrative embodiments. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

With the advancement of additive manufacturing systems, increased demands have been placed on every part of the system. Additive manufacturing systems have gotten faster, larger, and more intricate. One of the components in need of improvement is the powder recoater, which can include a blade, electrostatic, or other structure to smooth out the surface of the deposited powder. Some additive manufacturing systems cycle through relatively high temperatures, fluctuating between 40-60° C. and radiating large amounts of thermal energy into the recoater as it passes over the build surface. This temperature fluctuation can cause delamination to occur between the different materials present in the electrostatic recoater, as different materials such as glass, metal, or polymers have different thermal expansion constants and the excess heat causes the materials to expand at different rates and delaminate. Many additive manufacturing systems also operate in specialized environments, such as argon instead of air. However, argon has a significantly lower dielectric constant than that of air, which decreases the amount of voltage needed to cause corona discharge effects. In an electrostatic recoater, once argon infiltrates the electrode, it is possible for the corona discharges to occur and burn insulating material near the electrode. Furthermore, voltages in the magnitude of thousands may be required for the recoater to operate effectively. The increased voltages may lead to powder buildup issues on a scale that has not been considered before. For example, factors such as a flatness of a dielectric shield separating the recoater electrode from the powder bed, the dielectric constant of the dielectric shield, and any exposed elements on the recoater can cause increased powder buildup compared to recoaters employing lower voltages. Powder buildup, especially on parts such as the dielectric shield of the recoater, can cause uneven spread of layers of a powder material, which lead to inconsistencies in the final fused product. Finally, powder recoater systems often had to be entirely replaced whenever a part of the recoater broke, which was both costly and inefficient. The inventors have recognized these problems and a need for an electrostatic recoater of an additive manufacturing system adapted to deal with the new demands of the advancing technology.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface (e.g., a powdered metal material or other appropriate powder material) to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

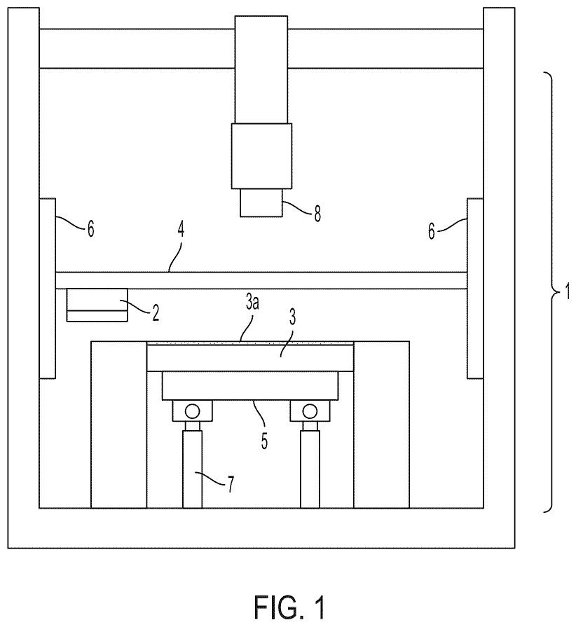

FIG. 1 depicts one embodiment of an additive manufacturing system 1 that incorporates one or more inventive features. In some embodiments, the system 1 includes a build plate 3 mounted on a base 5, which is in turn mounted on one or more vertical supports 7. The one or more vertical supports 7 can include any appropriate number of supports configured to support the build plate 3, and the corresponding build surface, at a desired position and/or orientation. For example, the supports 7 may include one or more actuators configured to control a vertical position and/or orientation of the build plate 3. In some embodiments, the additive manufacturing system may also include an optics assembly 8 that is supported vertically above and oriented towards the build plate 3. The optics assembly 8 may be optically coupled to one or more laser energy sources, not depicted, to direct laser energy in the form of one or more laser energy pixels onto the build surface of the build plate 3. To facilitate movement of the laser energy pixels across the build surface, the optics assembly may be configured to move in one, two, or any number of directions in a plane parallel to the build surface of the build plate. To provide this functionality, the optics assembly may be mounted on a gantry, or other actuated structure, that allows the optics unit to be scanned in a plane parallel to the build surface of the build plate 3.

The laser energy may be used to fuse precursor material 3a, such as a powdered metal material, in selected areas on the build surface to create a desired shape of fused material on the build surface. To provide the precursor material 3a on the build surface, the additive manufacturing system may include a powder deposition system that includes a recoater 2 mounted on a horizontal motion stage 4 that allows the recoater 2 to be moved across either a portion, or entire, surface of the build plate 3. As the recoater 2 traverses the build surface of the build plate 3, the recoater 2 may smooth the precursor material 3a, such as a powder, on the build plate to provide a layer of precursor material with a predetermined thickness on top of the underlying volume of fused and/or unfused precursor material deposited during prior formation steps. The recoater 2 may be moved vertically relative to the build plate 3 by a vertical motion stage 6, e.g., to provide subsequent layers of precursor material 3a on the build surface as a part is built. Alternately, the supports 7 may move the build plate 3 downwardly for each deposited layer of precursor material 3a and the recoater 2 may remain vertically stationary.

In the above embodiment, the vertical motion stages, horizontal motion stages, and gantry may correspond to any appropriate type of system that is configured to provide the desired vertical and/or horizontal motion. This may include supporting structures such as: rails; linear bearings, wheels, threaded shafts, and/or any other appropriate structure capable of supporting the various components during the desired movement. Movement of the components may also be provided using any appropriate type of actuator including, but not limited to, electric motors, stepper motors, hydraulic actuators, pneumatic actuators, electric actuators, and/or any other appropriate type of actuator as the disclosure is not so limited.

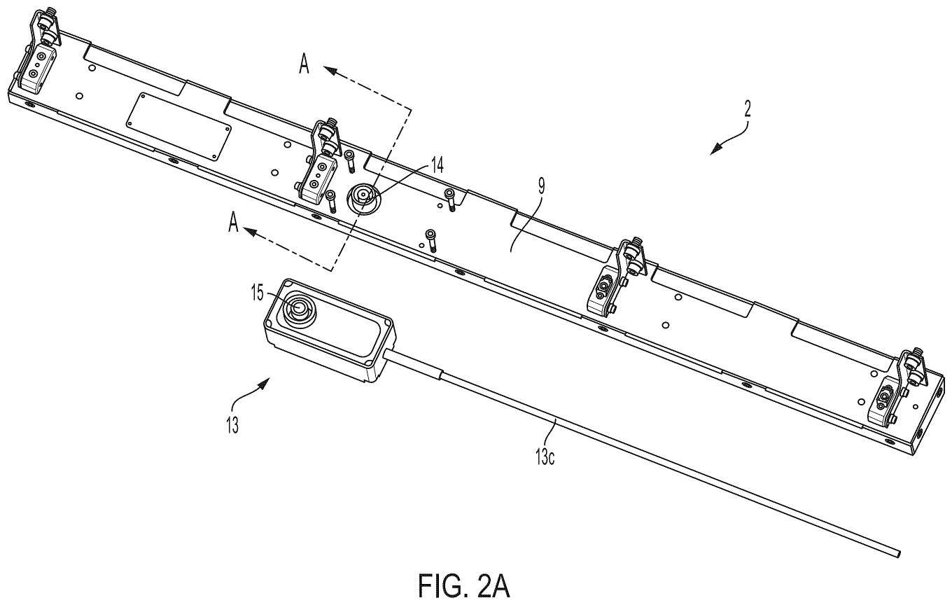

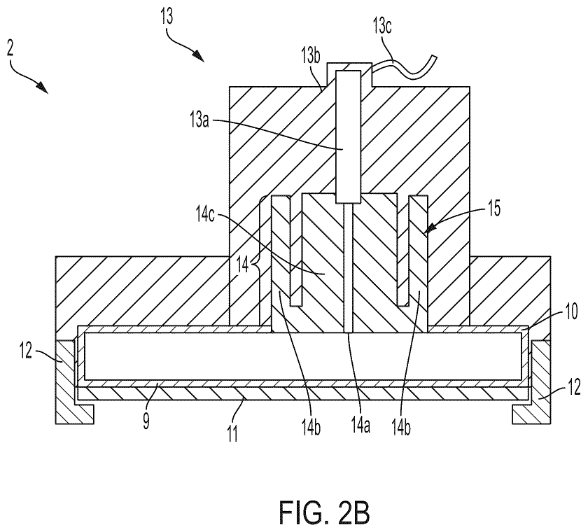

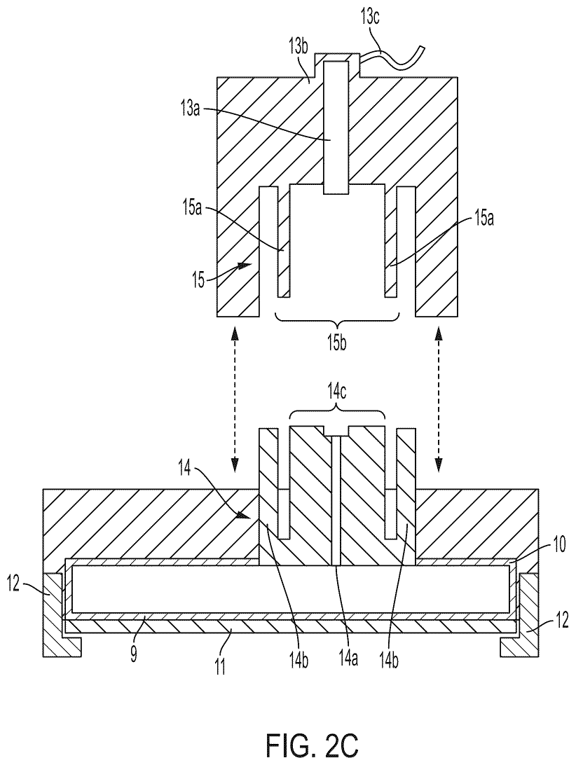

FIGS. 2A-2C depict an embodiment of an electrostatic recoater for an additive manufacturing system such as that in FIG. 1. The electrostatic recoater 2 includes an electrode 9, which may have a generally elongated rectangular shape (e.g., to span across all or a part of a build surface) and generate an electric field suitable to level, flatten or otherwise smooth a layer of powder metal material on a build surface when an alternating electric voltage is provided to the electrode 9. The electrode 9 can include a conductive element, such as copper (e.g., in the form of a rectangular sheet or layer), surrounded by an insulating material 10. In some cases, the conductive element and insulating material define a planar structure that includes a lower surface, e.g., that faces toward a powdered material layer to be smoothed. The electric field generated by the electrode 9 may pick up and redeposit or otherwise move a powder material on the build surface as the electrostatic recoater moves across the build surface to form a smooth surface of the precursor material 3a. A smooth layer of precursor material 3a is important to create a consistent build as layers of powder material are deposited and selectively melted on top of each other. A dielectric shield, such as a dielectric shield 11, may be a planar layer of dielectric material and positioned over the lower surface of the electrode 9 between the electrode 9 and the build surface, and may help prevent direct arcing from occurring between the build surface and the electrode 9 and/or electrostatic particle buildup on the electrode 9. In some cases, the electrode and dielectric shield can be configured to generate and expose a layer of powdered metal material to an electric field of −5 kV to +5 kV and smooth an upper surface of the layer of powdered metal material without contact.

In some embodiments, the insulator 10 prevents the electrode 9 from electrically connecting to unintended portions of the electrostatic recoater and/or prevents unwanted contact of conductive portions of the electrode 9 with external contaminants or gases that may cause damage to the system. For example, drifting metallic powder may induce an arcing event, which may generate significant heat or cause other problems, which can lead to damage to the recoater 2 or other components, and the insulator 10 may help resist the occurrence of such events. The insulator 10 may include any suitable insulating material such as a glass reinforced epoxy material such as FR4 or other suitable materials. In some cases, the insulator 10 may be applied as a coating on or adhered to the conductive portions of the electrode 9, e.g., using epoxy or other adhesive. The insulator 10 may have any suitable thickness, e.g., to help prevent arcing or other electrical discharge. The insulator 10 may be configured to reduce a thermal expansion/contraction mismatch between the electrode 9 and the insulator 10, which may help to prevent delamination.

In some embodiments, the electrostatic recoater may have mating conductive elements configured to selectively connect the electrode to an external power source. For example, a mating conductive element 14a coupled to the electrode 9 may connect to a mating conductive element 13a of a connector 13 to provide electrical power from a cable 13c to the electrode 9. In some cases, the connector 13 may include a socket 15 configured to receive a plug 14 that surrounds a portion of the conductive element 14a. The mating of the plug 14 and socket 15 allows the mating conductive elements 13a and 14a to electrically contact each other, creating an electrical pathway between the external power source and the electrode 9. The plug 14 and socket 15 may be configured to isolate the conductive elements 13a, 14a from an external environment, e.g., such that the mating conductive elements 13a and 14a, as well as the electrode 9, are isolated from inert gases employed by the additive manufacturing system at the build surface. The socket 15 and plug 14 can be removably coupled with each other, and may have a locking mechanism such that the socket 15 and plug 14 cannot disconnect from each other during operation of the electrostatic recoater. For example, the connector 13 can be fastened to the electrode 9 by one or more fasteners after the plug 14 and socket 15 are engaged. The socket 15, plug 14, and the conductive elements 13a and 14a may be designed such that the socket 15 and plug 14 may only be coupled together in one orientation, or they may be designed such that the socket 15 and plug 14 may be coupled together in multiple orientations. An insulating element in the form of a casing 13b on the connector 13 can protect the mating conductive elements 13a, 14a by preventing the path of electricity from being exposed to the external environment.

In some embodiments, the electrostatic recoater 2 may have a dielectric shield 11 coupled to the lower surface of the electrode 9, which can help prevent direct arcing between the build surface and the electrode 9, help prevent particle build up on the electrode, or aid in generating a suitable electrical field at the build surface. The dielectric shield 11 may have a dielectric constant of 5 to 7.2 at 1 MHZ, an electrical resistance of 10\hat{ }9 to 10\hat{ }13 Ohms, and/or a thickness of 0.5 mm to 3 mm. In some embodiments, the dielectric shield 11 may extend over a lower surface of the electrode 9 at an interface between the dielectric shield 11 and the electrode 9 and may be attached to the electrode so that the dielectric shield 11 and electrode 9 are moveable relative to each other in directions along the interface. An interface between the dielectric shield 11 and the electrode 9 can be defined as a shared plane along a top surface of the dielectric shield 11 and the lower surface of the electrode 9. The dielectric shield 11 and electrode 9 may be movable in directions relative to each other, e.g., in directions parallel to the plane of the interface. In some cases, the dielectric shield can shift in a horizontal plane, e.g., in any direction parallel to the plane of the interface. The attachment of the dielectric shield to the electrode that permits relative movement between the shield and electrode may allow the recoater to withstand a higher degree of thermal mismatch between the materials of the dielectric shield and the electrode, as both the dielectric shield and the electrode may move relative to each other in case of thermal expansion or contraction. In some cases, an adhesive, dielectric grease or other material may be provided at the interface between the electrode 9 and the shield 11, e.g., to help prevent entry of inert gas and/or precursor material into any space between the electrode and shield. The dielectric shield may be made of materials such as borosilicate glass, ceramics and or other suitable materials. A lower surface of the dielectric shield 11 may have a surface roughness of 0.8 micrometers RA to 0.012 micrometers RA, e.g., to aid in reducing the ability of powder material to adhere to the dielectric shield 11.

In some embodiments, the dielectric shield 11 may be removably coupled to a surface of the electrode 9, e.g., to a lower surface of the electrode 9 for positioning between the electrode 9 and precursor material 3a at the build surface. A removable dielectric shield may allow an operator to replace the dielectric shield in case repairs are needed, therefore increasing the overall lifetime of the electrostatic recoater, and reducing the costs and effort associated with maintenance. In some embodiments, the dielectric shield may be removably coupled to a surface of the electrode by a clamp, such as a bracket or frame, which can allow the position of the dielectric shield to be adjusted or removed from its coupling to the electrode. In some cases, a clamp 12 can engage with a portion of the dielectric shield 11, e.g., around a periphery of the dielectric shield 11 as shown in FIGS. 2A and 2B. In some embodiments, the clamp 12 can include one or more brackets engaged with the sides and/or bottom edges of the dielectric shield 11 to hold the dielectric shield to the lower surface of the electrode 9. A clamp 12 can be configured as a frame with inner edges defining an opening at which the dielectric shield 11 is exposed. The clamp can be positioned over the dielectric shield 11 such that a portion of the dielectric shield is positioned in the opening and inner edges of the clamp engage with portions of the dielectric shield to press the dielectric shield onto the lower surface of the electrode. For example, the clamp can apply a force on the shield 11 in a direction perpendicular to the lower surface of the electrode 9 to press the shield 11 into contact with the electrode. The frame-like clamp may be shifted or removed, allowing the dielectric shield 11 to be removed from its coupling to the electrode 9. In some embodiments, a clamp holding the dielectric shield to a lower surface of the electrode may have specially designed apertures, such as slots or latches, that allow the dielectric shield to be removed while maintaining the functionality of the electrostatic recoater. The clamp can be made of a material capable of withstanding thermal stress experienced during use of the recoater. The clamp may also be designed to minimize powder accumulation on the clamp, dielectric shield and/or electrode, e.g., having no exposed fasteners or other gaps or surface irregularities, e.g., to help prevent powder buildup on portions of the recoater.

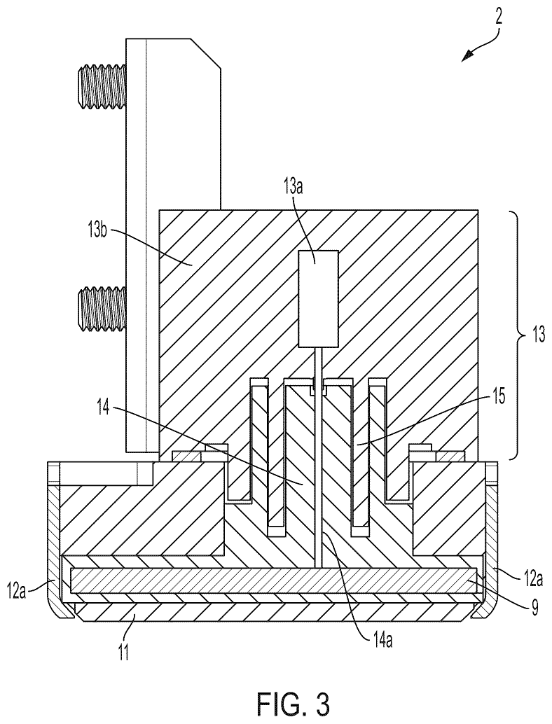

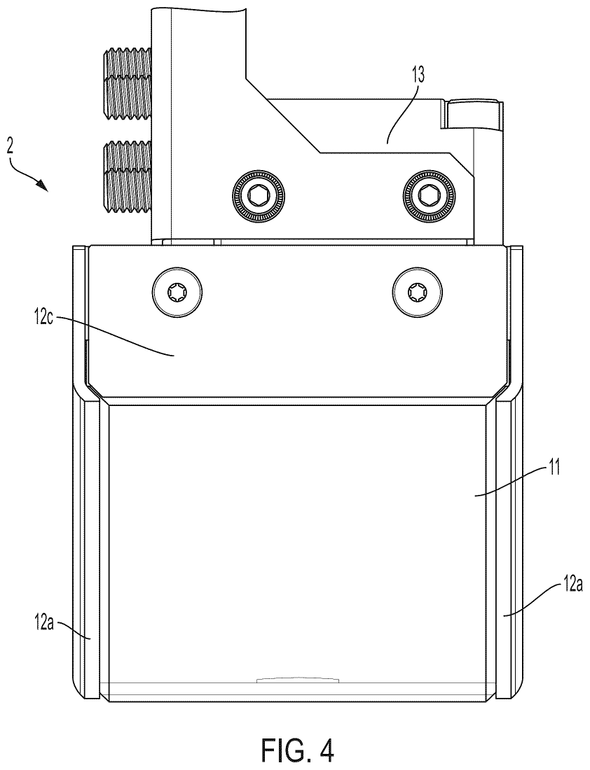

FIGS. 3 and 4 show one example of a dielectric shield 11 that is engaged at edges by a clamp 12 to secure the dielectric shield 11 to an electrode 9. In some embodiments, a clamp 12 includes two brackets 12a that extend along opposed edges of the dielectric shield 11 at sides of the electrode 9. The brackets 12a can engage the edges of the shield 11 such that the dielectric shield 11 is attached to the electrode 9 but remains movable relative to the electrode in directions along the interface between the electrode 9 and the shield 11. Although the brackets 12a are shown as single pieces extending along the length of the electrode 9 and shield 11, the brackets 12a may be one continuous piece or split into multiple smaller parts. In the FIGS. 3 and 4 embodiment, the dielectric shield 11 is at least movable in a direction parallel to the width and/or length of the electrostatic recoater 2, e.g., the engagement between the dielectric shield 11 and the brackets 12a may be configured to permit movement of the shield 11 relative to the electrode 9. The brackets 12a may extend over the side edges of the dielectric shield 11 to hold the dielectric shield 11 in place and limit movement of the dielectric shield away from the electrode 9. However, the dielectric shield may move in a plane parallel to the interface between the dielectric shield 11 and the electrode 9, e.g., in response to thermal stresses and/or physical impact. In some cases, the brackets 12a may extend over the edges of the dielectric shield 11 and contact the flat bottom surface of dielectric shield 11. The mounting mechanism may be any type of clamp to hold the dielectric shield at a location on the electrode, and may or may not rigidly couple the dielectric shield to the electrode. As can be seen in FIG. 4, brackets 12a may extend down first and second sides of the dielectric shield 11, e.g., to constrain movement of the dielectric shield 11 in a direction perpendicular to the length of the dielectric shield 11 and parallel to the interface between the dielectric shield 11 and the electrode 9. However, the third and fourth sides of the dielectric shield 11 at longitudinal ends of the shield 11 need not be held by any clamps. In some cases, a wall or bracket 12c may be provided at ends of the electrode 9 to limit movement of the shield 11 along its length. A gap may be provided between the wall or bracket 12c and the third or fourth ends of the dielectric shield 11, e.g., to allow the dielectric shield 11 to move at least to some extent in a direction along the length of the shield 11.

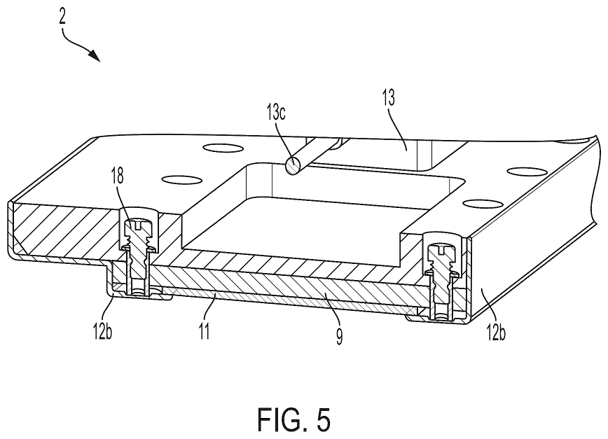

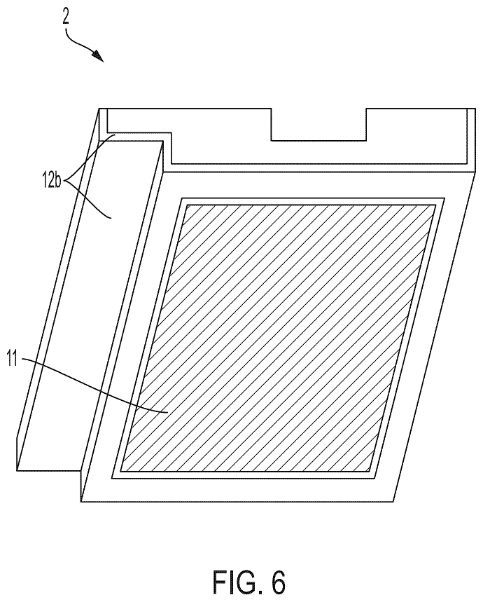

In some embodiments, the dielectric shield may be attached to the electrode by a frame with inner edges that define an opening. The frame may be positioned over the dielectric shield such that a portion of the dielectric shield is positioned in the opening and the inner edges of the frame engage with portions of the dielectric shield to press the dielectric shield onto the lower surface of the electrode. The frame can be mounted on the sides of the electrode and wrap around to the bottom of the electrostatic recoater to support the dielectric shield, or a frame may be mounted solely on a bottom surface of the electrostatic recoater. In some cases, a frame may constrain the dielectric shield to a maximum displacement in any direction in a plane parallel to the interface of the dielectric shield and electrode. The frame can be composed of a single piece of material, or multiple pieces joined together to support the dielectric shield, e.g., at a perimeter of the shield 11. FIGS. 5 and 6 show one example of a frame 12b that extends downwardly from the sides of the electrode 9 and has inner edges that define an opening to expose a portion of the dielectric shield 11. That is, the frame 12b may be positioned over the dielectric shield 11 such that a portion of the dielectric shield 11 is positioned in the opening and the inner edges of the frame engage with portions of the dielectric shield 11 to press the dielectric shield 11 onto a lower surface of the electrode 9. The frame 12b may engage with the dielectric shield 11 with sufficient force to hold the shield 11 in engagement with the electrode but permit the dielectric shield 11 to move in a plane parallel to an interface between the dielectric shield 11 and the electrode 9. However, the engagement between the frame and the dielectric shield may be suitable to prevent powder material entering gaps between the frame and the shield. Other suitable techniques for preventing powder or other precursor material from contacting the electrode on its lower surface may be employed, such as providing gaskets along the inner edges between the frame and the dielectric shield and/or an adhesive or similar element. For example, the frame 12 may be configured to include no exposed fasteners at lower and/or side portions of the recoater. FIG. 5 shows one such example where fasteners 18 used to secure the frame 12 and shield 11 to the electrode 9 extend downwardly through a portion of the electrode 9 to engage with an inner surface of the frame 12. However, the fasteners 18 are not exposed at lower and/or side portions of the recoater 2 and may be covered at upper portions of the recoater 2, e.g., a cover may be provided over the fasteners 18 at an upper side. Thus, the recoater 2 may be provided with an outer surface at least at lower portions and/or side portions that include a smooth contour with few or no surface irregularities. This smooth outer surface may aid in reduced powder or other material buildup on the recoater, e.g., due to electrostatic adherence, and permit the recoater to be wiped down, e.g., with a cloth or brush, to remove what little buildup may be present.

In some embodiments, the dielectric shield 11 may be removably coupled to a surface of the electrode for positioning between the electrode and the powder material. This can permit the dielectric shield to be replaced as needed, which was impossible in prior systems. For example, in some cases the dielectric shield 11 may be scratched by fused parts and/or precursor material on the build surface 3 as the electrostatic recoater 2 travels over the build surface 3 to smooth a new layer of powder. Powder may accumulate at scratch marks on the surface of the dielectric shield 11, and over time, the smoothness or flatness of the dielectric shield 11 may decrease and cause more powder buildup, causing the electrostatic recoater 2 to less ineffective. However, by designing the dielectric shield to be removable and replaceable, the lifetime of the electrostatic recoater 2 can be extended by replacing the dielectric shield 11 as necessary. In some embodiments, the dielectric shield may be removably coupled to a surface of the electrode by having the mounting mechanisms 12, such as a clamp 12, be removably coupled to the electrostatic recoater 2. Removable clamps may be mounted to the electrostatic recoater by mounting mechanisms comprising screws, latches, friction fits, and any other suitable mounting mechanisms. For example, the brackets 12a in FIGS. 3-4 can be adjusted and/or removed such that it is possible to remove the dielectric shield 11. The brackets 12a may be screwed onto a side and/or bottom surface of the electrostatic recoater 2, and to remove the dielectric shield 11, the brackets 12a simply have to be unscrewed from the electrostatic recoater 2. In the FIG. 4 embodiment, the dielectric shield 11 may also be removed by unscrewing a bracket or wall 12c from a side of the electrostatic recoater 2, which can allow the dielectric shield 11 to slide out in a direction parallel to the interface with the electrode 9. Similarly, the frame 12b in the FIGS. 5-6 embodiment may be removed by unscrewing the frame 12b from the electrostatic recoater, e.g., by removing fasteners 18 that pass through portions of the electrode and engage with the frame 12b. The mounting mechanisms may be specially designed to provide a removable coupling between the dielectric shield 11 and the electrode 9, such that there may be special slots and/or latches. These special slots or latches may allow the dielectric shield to be removed without removing any part of the mounting mechanisms from the electrostatic recoater.

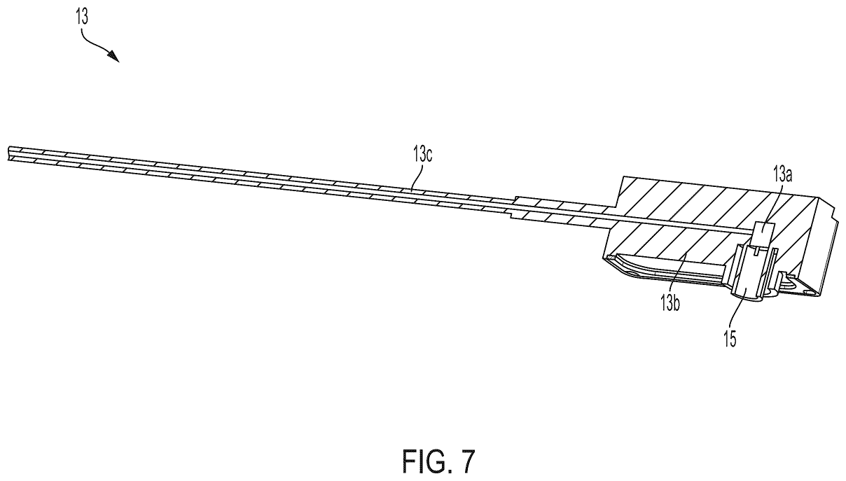

As noted above, the electrostatic recoater may be powered through a connector 13, which extends between the electrode 9 and the cable 13c to provide the electrode 9 with the alternating electric voltage needed to generate an electric field. The connector includes conductive elements configured to selectively connect the electrode to the cable and is configured to isolate the mating conductive elements from argon gas in an external environment around the connector. In some embodiments, the connector may also include a pathway extending along mating surfaces of the connector to the external environment and the connector may be configured to isolate a portion of the pathway extending a distance from the mating conductive elements toward the external environment from argon gas. The mating surfaces may be exposed to relatively high voltage, e.g., a voltage applied to the electrode 9, and may be formed by electrically insulating components. One example of such a connector is shown in FIG. 7, which has a mating element that includes a socket 15 and a mating conductive element 13a. The mating conductive element 13a is covered by an insulating casing 13b except for its exposure at the center of socket 15, where it connects to another mating conductive element on the electrostatic recoater electrode. The connector 13 is electrically connected to an external power source through the cable 13c, which has a conductive core leading to the mating conductive element 13a and is insulated from the external environment by being covered by an insulating material such as rubber.

In some embodiments, the connector 13 may be made gas proof or otherwise gas resistant by use of a labyrinth seal. By preventing gases from infiltrating the mating surfaces of the connector and reaching a conductive element, it is possible to decrease the likelihood of any arcing or other short circuit events. For example, many manufacturing processes may operate in an environment filled with inert gases such as argon. Some inert gases have a lower dielectric constant than standard air, which enables arcing events to occur at lower voltage potentials. Coupled with the high voltages used by a recoater electrode, the presence of inert gas at the recoater connector can cause arcing events to be more likely to occur. For example, inert gas may penetrate into areas of a connector at or near conductive components that carry relatively high voltage. The lower dielectric constant of the inert gas can permit arcing through the inert gas to areas outside of the connector, such as an external surface of the recoater. This may cause parts of the connector such as the insulating casing 13b or other insulating part to melt or carbonize. Carbonization of insulating parts may cause the parts to have relatively low resistance, at least along the carbonized path, allowing electricity to travel from the conductive elements to a casing of the electrostatic recoater. To avoid such problems, a connector can be provided with an increased path length along portions where inert gas may penetrate and/or provided with features to resist penetration by inert gas. For example, FIGS. 2A, 2B and 3 show a connector arrangement with a double labyrinth seal provided by the socket 15 and a plug 14. The double labyrinth seal creates a tortuous pathway for gases to travel, e.g., from the external surface of the casing 13b of the connector and the electrode 9 to the mating conductive elements 13a and 14a. That is, the mating surfaces of the plug 14 and socket 15 may provide a tortuous and/or relatively long pathway from an external surface of the connector and recoater to the conductive elements 13a, 14a so that even if relatively low dielectric constant gas penetrates into the pathway, arcing or other short circuiting will be minimized. The pathways of labyrinth seals are bent in tortuous ways and/or are relatively long. In some cases, the tortuous pathway provided by the plug 14 and socket 15 may be formed by arranging the plug 14 to have an outer sleeve 14b spaced from an inner core 14c by a gap that has a length approximately equal to the length of the sleeve and inner core. The conductive element 14a connected to the electrode 9 may extend along a center of the inner core. The socket 15 may be shaped in a complementary way to the plug, e.g., to receive the outer sleeve and inner core of the plug 14. For example, the socket 15 may include an annular sleeve 15a that extends from a cavity 15b of the connector body and is positioned around the conductive element 13a. The annular sleeve of the socket 15 may extend into the gap between the outer sleeve and the inner core of the plug 14, e.g., with a close fit so that the mating surfaces have little to no space between them. Other features may be provided to help resist entry of gas into any area between the mating surfaces of the plug 14 and socket 15, such as one or more gaskets between the plug 14 and socket 15, e.g., between the outer sleeve and the connector body, between the annular sleeve 15a and the plug 14, between the connector body and the electrode and/or others to create a seal that resists entry of argon or other gas into spaces between mating insulating portions of the connector and electrode. In some embodiments, portions of the pathway extending along the mating surfaces of the connector from the conductive elements to the external environment may be filled with an adhesive and/or an insulating fluid such as a dielectric grease to resist entry of gas into the pathway and/or increase an effective dielectric constant of the pathway. The areas around the connector 13 and/or the mating surfaces between the connector 13 and the electrode 9 may be filled or covered with an adhesive, e.g., epoxy, to resist gas entry. The mating surfaces between the connector 13 and the electrode 9 may form tortuous pathways which makes it difficult for liquids to travel through, such as labyrinth seals, to hold an adhesive and/or insulating fluid in place such that a tight seal is formed to prevent gas from infiltrating in from the external environment. Adhesives and/or insulating fluids can be viscous, further improving the effectiveness of labyrinth seals in holding them in place as a seal. The connector can be configured to isolate conductive components of the connector through any combination of suitable techniques.

The plug 14 and socket 15 may be engaged at the top surface of the electrostatic recoater 2, e.g., to avoid interference with the operation of the electrostatic recoater 2. In some embodiments, the plug 14 and socket 15 may be designed to be connected at any surface of the electrostatic recoater 2 provided the connector 13 does not interfere with the operation of the electrostatic recoater 2.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. An electrostatic recoater for leveling a powder material for an additive manufacturing system, the electrostatic recoater comprising:
an electrode having a lower surface and configured to generate an electric field below the lower surface when provided with an alternating electric voltage; and
a dielectric shield extending over the lower surface at an interface between the dielectric shield and the electrode, the dielectric shield being attached to the electrode such that the dielectric shield and the electrode are movable relative to each other in directions along the interface.

2. The recoater of claim 1, wherein the interface is planar and the dielectric shield and electrode are movable relative to each other in directions parallel to the plane of the interface.

3. The recoater of claim 1, further comprising a clamp that applies a force to the dielectric shield in a direction perpendicular to the lower surface of the electrode to hold the dielectric shield in contact with the lower surface.

4. The recoater of claim 3, wherein the clamp includes a frame with inner edges that define an opening, the clamp positioned over the dielectric shield such that a portion of the dielectric shield is positioned in the opening and the inner edges of the clamp engage with portions of the dielectric shield to press the dielectric shield onto the lower surface of the electrode.

5. The recoater of claim 1, wherein the dielectric shield is a planar layer of dielectric material.

6. The recoater of claim 1, further comprising an interface layer between the dielectric shield and the electrode at the interface.

7. The recoater of claim 6, wherein the interface layer includes an adhesive configured to adhere to at least the dielectric shield.

8. The recoater of claim 1, wherein the electrode includes a conductive element surrounded by an insulating material, the conductive element and insulating material defining a planar structure that includes the lower surface.

9. The recoater of claim 1, wherein the electrode and dielectric shield are configured to generate and expose a layer of powder material to an electric field and smooth an upper surface of the layer of powder material without contact.

10. The recoater of claim 1, wherein the dielectric shield is made of a borosilicate glass or ceramic material.

11. The recoater of claim 1, wherein the dielectric shield has a dielectric constant of 5.0 to 7.2 at 1 Mhz.

12. An electrostatic recoater for leveling a powder material for an additive manufacturing system, the recoater comprising:
an electrode configured to generate an electric field when provided with an alternating electric voltage; and
a dielectric shield removably coupled to a surface of the electrode for positioning between the electrode and the powder material.

13. The recoater of claim 12, wherein an interface between the electrode and the dielectric shield is planar and the dielectric shield and electrode are movable relative to each other in directions parallel to the plane of the interface.

14. The recoater of claim 12, further comprising a clamp that applies a force to the dielectric shield in a direction perpendicular to the lower surface of the electrode to hold the dielectric shield in contact with the lower surface.

15. The recoater of claim 14, wherein the clamp includes a frame with inner edges that define an opening, the clamp positioned over the dielectric shield such that a portion of the dielectric shield is positioned in the opening and the inner edges of the clamp engage with portions of the dielectric shield to press the dielectric shield onto the surface of the electrode.

16. The recoater of claim 12, wherein the dielectric shield is a planar layer of dielectric material.

17. The recoater of claim 12, further comprising an interface layer between the dielectric shield and the electrode.

18. The recoater of claim 17, wherein the interface layer includes an adhesive configured to adhere to at least the dielectric shield.

19. The recoater of claim 12, wherein the electrode includes a conductive element surrounded by an insulating material, the conductive element and insulating material defining a planar structure that includes the surface.

20. The recoater of claim 12, wherein the electrode and dielectric shield are configured to generate and expose a layer of powder material to an electric field and smooth an upper surface of the layer of powder material without contact.

21. A method for additive manufacturing, the method comprising:
providing an alternating electric voltage to an electrode;
generating an electric field below a lower surface of the electrode, wherein a dielectric shield extends over the lower surface at an interface between the dielectric shield and the electrode; and
permitting movement of the electrode and the dielectric shield relative to one another in directions along the interface.

22. The method of claim 21, wherein the interface is planar and wherein moving the electrode and/or the dielectric shield the dielectric shield relative to one another in directions along the interface includes moving the electrode and/or the dielectric shield relative to one another in directions parallel to the plane of the interface.

23. The method of claim 21, further comprising a applying a force using a clamp to the dielectric shield in a direction perpendicular to the lower surface of the electrode to hold the dielectric shield in contact with the lower surface.

24. The method of claim 21, wherein the dielectric shield is a planar layer of dielectric material.

25. The method of claim 21, further comprising exposing a layer of powder material to the electric field using the electrode and dielectric shield, and smoothing an upper surface of the layer of powder material without contacting the upper surface of the powder material.

26. The method of claim 25, further comprising fusing at least a portion of the layer of powder material with one or more laser energy pixels to form one or more parts on a build surface.

27. The method of claim 21, wherein the dielectric shield has a dielectric constant of 5.0 to 7.2 at 1 Mhz.

28. A part manufactured using the method of claim 21.

29. A method for additive manufacturing, the method comprising:
providing an alternating electric voltage to an electrode to generate an electric field;
removably coupling a dielectric shield to a surface of the electrode to position the dielectric shield between the surface of the electrode and a layer of powder material; and
leveling the layer of powder material using the electric field.

30. The method of claim 29, wherein an interface between the electrode and the dielectric shield is planar and further comprising moving the dielectric shield and the electrode relative to one another in directions parallel to the plane of the interface.

31. The method of claim 29, further comprising using a clamp to apply a force to the dielectric shield in a direction perpendicular to the lower surface of the electrode to hold the dielectric shield in contact with the lower surface.

32. The method of claim 31, further comprising providing a frame for the clamp with inner edges that define an opening, positioning the clamp over the dielectric shield such that a portion of the dielectric shield is positioned in the opening and the inner edges of the clamp engage with portions of the dielectric shield to press the dielectric shield onto the surface of the electrode.

33. The method of claim 29, further comprising providing the dielectric shield as a planar layer of dielectric material.

34. The method of claim 29, further comprising providing an interface layer between the dielectric shield and the electrode.

35. The method of claim 34, further comprising adhering the interface layer to at least the dielectric shield using an adhesive.

36. The method of claim 29, further comprising providing a conductive element surrounded by an insulating material, the conductive element and insulating material defining a planar structure that includes the surface.

37. The method of claim 29, further comprising exposing a layer of powder material to the electric field and smoothing an upper surface of the layer of powder material without contact.

38. The method of claim 37, further comprising fusing at least a portion of the layer of powder material with the one or more laser energy pixels to form one or more parts on a build surface.

39. A part manufactured using the method of claim 29.
